(19) United States
(12) Patent Application Publication
(10) Pub. No.: US 2020/0091533 A1
(43) Pub. Date: Mar. 19, 2020

(54) METHOD FOR PRODUCING A MEMBRANE ELECTRODE ASSEMBLY FOR A FUEL CELL, AND PRODUCTION LINE

(71) Applicant: Compagnie Generale des Etablissements Michelin, Clermont-Ferrand (FR)

(72) Inventor: OLIVIER JOYE, Clermont-Ferrand (FR)

(21) Appl. No.: 16/470,770

(22) PCT Filed: Dec. 8, 2017
(86) PCT No.: PCT/FR2017/053467

§ 371 Date: Jun. 18, 2019

(30) Foreign Application Priority Data
Dec. 20, 2016 (FR) 16/62833

(51) Int. Cl. H01M 8/1004; H01M 8/0273; H01M 8/0286; H01M 8/04119; H01M 4/88

(52) U.S. Cl. CPC H01M 8/1004; H01M 8/0273; H01M 4/8896; H01M 8/04149; H01M 8/0286

(57) ABSTRACT

A method for manufacturing a membrane electrode assembly for a fuel cell, comprising a membrane, two reinforcers, two seals, gas diffusion layers and a catalyst, comprises the following steps: a step during which a seal is applied to each of the reinforcers using screen printing, a step during which a catalytic chemical element is applied to the membrane, a step during which a reinforcement bearing a screen-printed seal is thermally bonded to each of the faces of the catalysed membrane, and a step during which a gas diffusion layer is applied to each of the faces of the catalysed membrane bearing a reinforcer and a seal, the method being such that the various elements are held on a support by suction during at least some of the steps of the method. There is also a corresponding production line.

### FIELD OF THE INVENTION

The present invention relates to the field of fuel cells and more particularly to the field of the manufacture and assembly of fuel cells.

A fuel cell makes it possible to generate electrical energy through an electrochemical reaction based on a fuel, generally hydrogen, and on a combustion agent, generally oxygen.

A fuel cell of solid-electrolyte proton exchange membrane type (PEMFC) normally comprises a stack of elementary cells, in the form of plates, forming electrochemical generators, each of the cells being separated from the adjacent cells by bipolar plates. Each cell comprises an anode element and a cathode element, separated by a solid electrolyte in the form of an ion-exchange membrane that is made for example from a perfluorinated sulfurated polymeric material.

This assembly comprising the cathode element, the anode element and the solid electrolyte forms a membrane electrode assembly also known as an MEA. According to one common form of embodiment, each bipolar plate provides, on one side, the supply of fuel to the cell adjacent to this side and, on the other side, the supply of combustion agent to the cell adjacent to this other side, the supplies provided by the bipolar plates being carried out in parallel. Gas diffusion layers, for example made of carbon cloth, are installed on either side of the MEAs in order to provide electrical conduction and a homogenous arrival of the reaction gases supplied via the bipolar plates.

The present invention seeks to propose a method for the manufacture of membrane electrode assemblies for fuel cells.

### BRIEF DESCRIPTION OF THE INVENTION

Thus, the invention relates to a method for manufacturing a membrane electrode assembly for a fuel cell, comprising a membrane, two reinforcers, two seals, gas diffusion layers and a catalyst, the method comprising the following steps:
a step during which a seal is applied to each of the reinforcers using screen printing,
a step during which a catalytic chemical element is applied to the membrane,
a step during which a reinforcer bearing a screen-printed seal is thermally bonded to each of the faces of the catalysed membrane,
a step during which a gas diffusion layer is applied to each of the faces of the catalysed membrane bearing a reinforcer and a seal,
   the method being such that the various elements are held on a support by suction during at least some of the steps of the method.

It is emphasized here that, in the remainder of the description, the expression “catalytic chemical element” can be replaced by the term “catalyst” for the sake of simplifying the description. This catalytic chemical element is preferably an ink containing platinum, water and solvents.

The use of a catalysed membrane makes it possible to simplify the later assembly steps. This is because a membrane which has two layers of catalyst is more stable than an un-catalysed membrane and is therefore easier to handle.

The application of the gas diffusion layers does not necessarily entail thermo bonding or hot pressing. Specifically, these layers may be held only by pressure when the cell made up of a succession of membrane electrode assemblies and of bipolar plates is being stacked.

In one embodiment, the step during which a catalytic chemical element is applied to the membrane is performed using a direct-deposition method included in the group comprising: flexography, screen printing and coating. The catalysing of the membrane could also be performed after the reinforcers have been applied to the membrane. In that case, the use of methods such as flexography or screen printing, which allow for the printing of patterns, would be particularly advantageous.

In another embodiment, referred to as “indirect”, the step during which a catalytic chemical element is applied to the membrane is performed using an indirect-deposition method including the following steps:
a step of applying the catalytic chemical element to a Teflon support using a method comprised in the group including flexography, screen printing and coating, and
a step of transferring the catalytic chemical element from the support onto the membrane using a hot rolling method.

The catalyst is generally applied in the form of an ink containing solvents. Before the catalysed membrane is handled, it is beneficial to wait until the solvents have finished evaporating. If it is desirable to shorten this waiting time, it is possible, in one preferred embodiment, to provide a catalyst-drying step.

Likewise, in a preferred embodiment, the step during which a seal is applied by screen printing comprises a step of polymerization and of drying of the seals.

In yet another embodiment, the step during which a seal is applied by screen printing comprises a step of inspecting the quality of the seal. This step can be performed by an HD camera which checks the geometry of the seal, or by a laser reader which measures the geometry of the seal in three dimensions. This step may be further supplemented by a step of inscribing a serial number and/or an identity number on the reinforcers+seals assembly, this inscription being performed for example by inkjet or by laser or dot-matrix printing.

In one embodiment of the invention, the hot-bonding step is performed at a temperature comprised between 100° C. and 150° C., and more preferably still, at a temperature comprised between 100° C. and 120° C.

The invention also relates to a production line for manufacturing membrane electrode assemblies, comprising a circuit allowing a carriage on which a mould made up of porous metal segments is moved from one manufacturing workstation to another, each of the workstations allowing implementation of one or another of the steps of a method.

### BRIEF DESCRIPTION OF THE FIGURES

Further objectives and advantages of the invention will appear more clearly from the description below of a preferred but non-limiting embodiment illustrated by the following figures in which:

FIG. 1 schematically shows all of the steps of a method for assembling a fuel cell implementing a manufacturing method according to the invention,

FIG. 2 shows a screen printing method that can be implemented in a method according to the invention,

FIG. 3 shows a flexography method that can be implemented in a method according to the invention, and

FIG. 4 shows an assembly line that can be implemented in a method according to the invention.

### DESCRIPTION OF THE BEST EMBODIMENT OF THE INVENTION

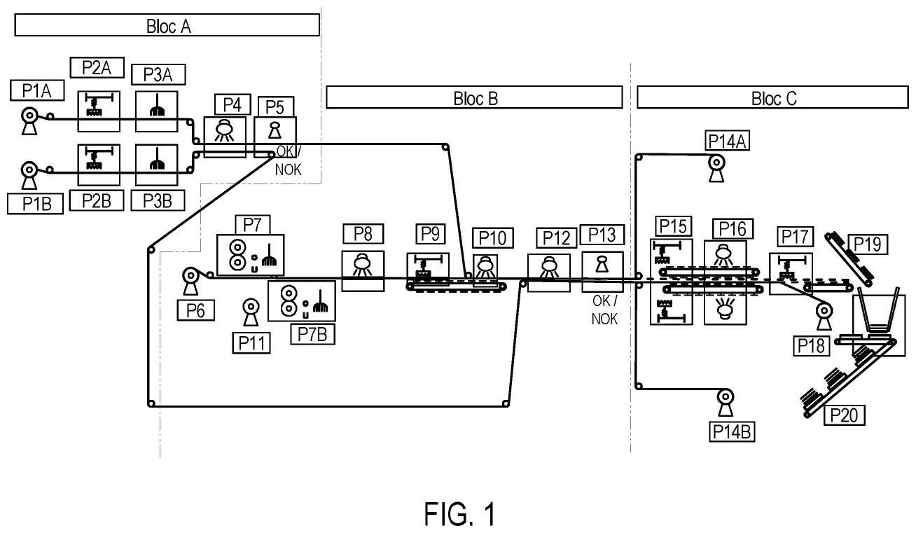

FIG. 1 shows the steps of a method according to the invention. This method is schematically divided into three main sections:
a section A corresponding to the application of the seals to the reinforcers by screen printing,
a section B corresponding to the preparation of the membranes and the integration thereof between the reinforcers,
a section C corresponding to the installation of the gas diffusion layers and to the final assembly of the fuel cell.
   Each of these sections is made up of several steps which will be described in detail. In FIG. 1, each step is indicated by a pictogram indicating the hardware means needed for implementing this step.

Application of the seals to the reinforcers by screen printing: The reinforcers used in the fuel cells are polymer films which generally come in the form of rolls. Steps P1A and P1B therefore correspond to a step of unwinding two reinforcers, respectively an upper reinforcer (P1A) and a lower reinforcer (P1B). These rolls of reinforcer come with reactivatable adhesive present on one face.

Once the reinforcers have been unwound, they are cut, in steps P21 and P2B respectively. The cuts, which are made by a laser or by stamping, make it possible to create the interior shapes of the reinforcer. Specifically, the reinforcing elements are intended to be positioned later so that they sandwich the edge of the membrane around its entire periphery, while leaving a central part of the membrane uncovered.

Steps P3A and P3B correspond to the application of the seals to the upper and lower reinforcer, by screen printing.

After the seals have been applied by screen printing, a step P4 of polymerizing and drying the seals is provided. In one particular embodiment, the seals are positioned on a carriage which moves through a tunnel, for example of a length of four metres at a speed of 1.5 metres per minute, the tunnel being held at an internal temperature of between 110° C. and 150° C.

The quality of each of the “reinforcer+seal” assemblies is then inspected during step P5. This quality control check is performed for example by a high-definition camera or by a laser reader. The “reinforcer+seal” assemblies are then ready to be applied to a catalysed membrane, as described in the paragraphs which follow.

Preparation of the membranes and the integration thereof between the reinforcers: A method according to the invention uses a catalysed membrane. To this end, step P7 plans for the application of a catalytic chemical element to the anode side of the membrane, and step P7B provides for the application of a catalytic chemical element to the cathode side of the membrane. This application is performed for example using screen printing, using flexography, using coating or using spraying.

In another exemplary embodiment, the catalyst is printed onto a sheet of Teflon and is then transferred onto the membrane by a hot-rolling method.

The membrane is a polymer film which generally comes as a roll between two interleaf sheets. Thus, advantageously, the method comprises, prior to step P7, a step P6 during which the membrane is unwound and the first interleaf sheet is removed. Furthermore, a step P11, situated between steps P7 and P7B, allows the second inter leaf sheet to be removed so as to allow the catalysis of the second face during step P7B.

After the application of the catalytic chemical element, the catalyst needs to be dried. For this purpose, in a step P8, the catalysed membrane is placed in an oven at 45° C. for 1 minute. The membrane is then cut, during a step P9, to the format, corresponding to the desired stack, using a cutter. During this cutting step, the membrane is held in position by suction using suction cups or by sintered aluminium supports.

The first “reinforcer+seal” assembly, coming from section A, is then, in a step P10, bonded to the upper face of the catalysed membrane. The hot-bonding is then performed at a temperature for example comprised between 100° C. and 150° C., preferably between 100° C. and 120° C.

Next, in step P12, the second “reinforcer+seal” assembly is bonded to the lower face of the catalysed membrane. This bonding is performed under the same conditions as that of step P10. The quality of the membrane+reinforcers+seals assembly is then inspected, for example using a high-definition camera, in step P13.

Advantageously, steps P10 and P12 may be performed simultaneously, and the reinforcers are thus pressed onto the two faces at the same time.

Installation of the as diffusion layers and final assembly: Before being able to install the gas diffusion layers, it is beneficial to cut them, in a step P15. Prior to this, the rolls of carbon cloth intended to form the gas diffusion layers are paid out in steps P14A and P14B.

The diffusion layers are then applied to each of the faces of the “catalysed membrane+reinforcers+seals” assembly. It is emphasized here that there is no need to perform any bonding at this stage. This is because the diffusion layers may be held in place by mechanical pressure upon subsequent assembly of the fuel cell. Step P17 is a final cutting step, cutting around the outside of the membrane electrode assembly and the gas manifolds of the fuel cell. The waste from this cutting operation is removed during step P18, and step P19 corresponds to the arrival of the bipolar plates and to alternating stacking of a membrane electrode assembly/a bipolar plate, in order to obtain, at step P20, a complete fuel cell.

Screen Printing and Flexography:

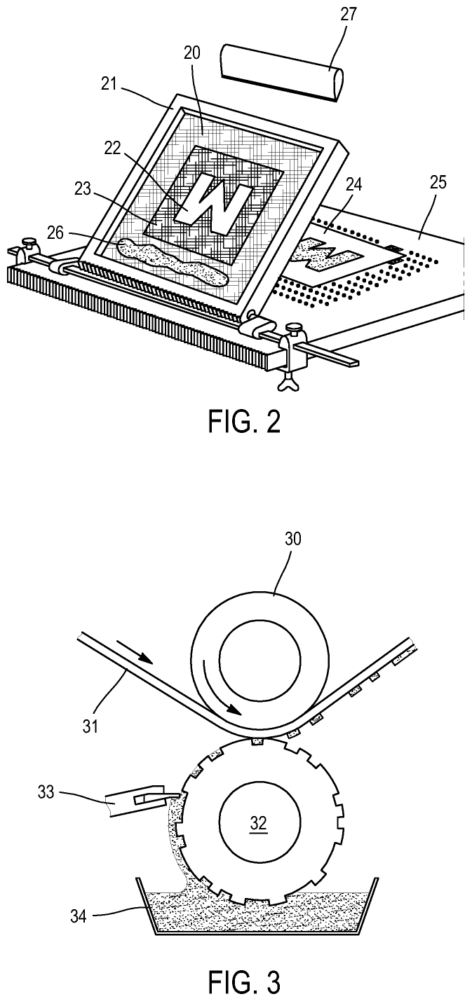

FIG. 2 shows a system making it possible to implement a screen printing method as used in several steps of the present invention. This system comprises a screen or frame 20, formed from a PET cloth 21, also referred to as mesh, of which the mesh openings and filament diameter can be adapted to suit various uses.

In order to create the pattern that is to be produced, the cloth is coated with a photosensitive product referred to as an emulsion to which there is applied a stencil corresponding to the pattern to be produced. In this instance, the pattern to be produced corresponds to the central part of an ion exchange membrane, left uncovered after the reinforcers are installed.

After having experienced exposure to a UV lamp, the photosensitive product cures with the exception of the zone masked by the stencil. The surplus is then cleaned off. Thus, the mesh therefore comprises open mesh cells 22, that form the pattern, and closed mesh cells 23.

Once this frame, or screen, has been manufactured, it is then possible to perform an application of catalyst using screen printing. In order to do this, the membrane 24, possibly catalysed on one face, is installed on the support 25 with the non-catalysed face facing upwards. The screen 20 is then positioned on the support 25, on top of the membrane 24. A sufficient quantity of catalyst 26 is then applied to the frame and spread evenly over the pattern without pressing down too hard, so as to prevent it from passing through the mesh. This operation is referred to as “coating”.

A scraper 27 formed of a polyurethane or metal profile, the hardness and stiffness of which can be adapted, is then passed over the entire length of the profile at a variable angle close to 45°. It is emphasized here that the frame 20 is installed a little above the support 25 so as to avoid contact between the two before the scraper is passed across.

The scraper 27 will then force the mesh 21 to deform, bringing it into contact with the support 32. The catalyst is then forced, upon the passage of the scraper, to pass through the mesh and become deposited on the membrane 24.

The scraper also scrapes off the surplus catalyst on the surface of the screen, this screen then being ready for a second application.

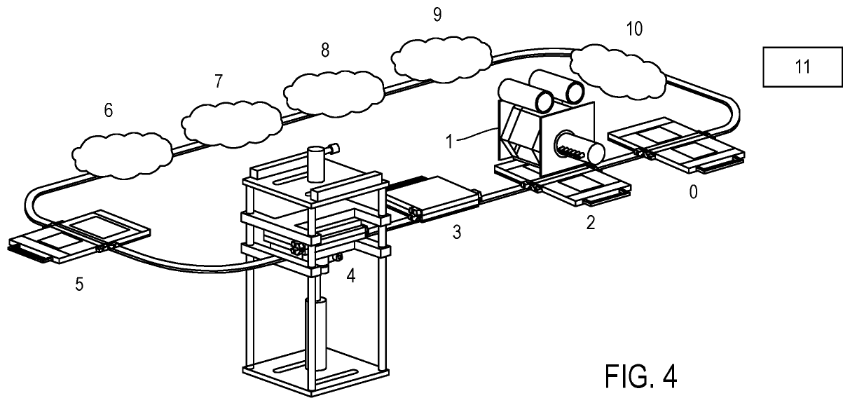

FIG. 3 illustrates another method for applying this deposit in the form of a pattern, namely a flexography method also known as an “ink pad” method. The system shown in FIG. 4 comprises a support cylinder 30 on which the membrane 31 to be catalysed is installed. The system also comprises an inking cylinder 32 on which the pattern to be applied is formed as a raised thickness. The system additionally comprises a roller 33 intended to eliminate, after dipping in the tank 34, the ink present on those parts of the inking cylinder that do not form the pattern.

Thus, upon contact between the support cylinder 30 and the inking cylinder 32, the pattern designed on the inking cylinder 32 is transferred onto the membrane 31.

Assembly line: FIG. 4 shows one example of an assembly line that can be implemented in a method according to the invention. This line comprises a circuit 100 allowing a carriage, on which is installed a porous metal mould 200 which will act as a support in the various assembly steps of the method, to move. In FIG. 4, certain workstations are depicted in detail, while others are simply schematically indicated.

The use of a porous metal means that vacuum pumps, not depicted in the figure, can be connected up underneath the mould to allow the various elements to be held in position on the mould.

At the entry to the assembly line, at the point 0, the mould receives two “reinforcer+seal” assemblies, for example coming from step P6 of FIG. 1. Hereinafter, in order to simplify the description, these assemblies will be referred to simply as “reinforcers”.

The workstation 1 is a workstation for handling the catalysed membrane 300. Thus, the mould bearing the reinforcers and seals positions itself beneath the workstation 1 and accepts the catalysed membrane on one of the two reinforcers. At the workstation 3, the mould is closed again, allowing the second reinforcer to be positioned. Once the 2^{nd} reinforcer is in position on the catalysed membrane, the mould is opened again. The workstation 4 allows hot pressing, at a temperature preferably situated between 100° C. and 120° C. The pressing action is performed by the vertical thrust of an actuating cylinder installed underneath the mould when the mould is present in the workstation and in abutment at the top against a blocking plate.

The assembly line then comprises the following workstations:
the workstation 5 allows cooling of the reinforcers+membrane assembly,
at the workstation 6, a gas diffusion layer is applied to a first face of the membrane, and the mould is closed again. It is emphasized here that, in certain instances, the gas diffusion layer includes a band of adhesive. This band of adhesive is applied via an adhesive-application device and, in that case, the assembly line comprises a robot equipped with a suction cup or with an electrostatic gripper in order to transport the gas diffusion layer from the adhesive-application device to the assembly line.
at the workstation 7, the assembly is turned over so that the second face of the membrane becomes the upper face; this turning-over is performed by simply opening the mould, combined with a suction command on each of the plates of the mould. Specifically, when the mould is opened, the plate the suction on which has been cut off will not carry away any element, when the assembly remains attached to the plate on which the suction is maintained,
at the workstation 8, a gas diffusion layer is applied to the second face of the membrane, and the mould is closed again,
at the workstation 9, the assembly is hot-pressed using means similar to those of workstation 4. Nevertheless, it must be emphasized that this hot-pressing step is optional,
at workstation 10, the mould is opened, and serial or identification numbers are possibly printed onto the assembly using inkjet, laser printing or dot-matrix printing.
finally, at workstation 11, the MEA is recovered for a final trimming step corresponding to step P17 in FIG. 1.

All of these operations take place in a controlled atmosphere in terms of dust, temperature and humidity in order to avoid degradation of the assembly. Furthermore, as previously indicated, a vacuum is created at each workstation on the plates of the mould in order to manage how the various elements are attached to the mould. In one preferred embodiment, the moulds are equipped with emergency reservoirs to alleviate the effect of any micro-leakage that might occur as the mould is being transferred between two workstations.

1.-8. (canceled)

9. A method for manufacturing a membrane electrode assembly for a fuel cell, comprising elements including a membrane, two reinforcers, two seals, gas diffusion layers and a catalyst, the method comprising the following steps:
applying a seal to each of the reinforcers using screen printing;
applying a catalytic chemical element to the membrane;
thermally bonding a reinforcer bearing a screen-printed seal to each of the faces of the catalyzed membrane; and
applying a gas diffusion layer to each of the faces of the catalyzed membrane bearing a reinforcer and a seal,
wherein the elements are held on a support by suction during at least some of the steps of the method.

10. The method according to claim 9, wherein the applying a catalytic chemical element step is performed using a direct-deposition method selected from the group consisting of flexography, screen printing and coating.

11. The method according to claim 9, wherein the applying a catalytic chemical element step is performed using an indirect-deposition method including the following steps:
applying the catalytic chemical element to a Teflon support using a method selected from the group consisting of flexography, screen printing and coating; and
transferring the catalytic chemical element from the support onto the membrane using a hot rolling method.

12. The method according to claim 10, wherein the applying a catalytic chemical element step further comprises a step of drying the catalyst.

13. The method according to claim 9, wherein the applying a seal step comprises a step of polymerization and of drying of the seal.

14. The method according to claim 9, wherein the applying a seal step comprises a step of inspecting the quality of the seal.

15. The method according to claim 9, wherein the thermally bonding step is performed at a temperature between 100° C. and 150° C.

16. A production line for manufacturing membrane electrode assemblies comprising a circuit allowing a carriage, on which is installed a mold made up of porous metal segments, to be moved from one manufacturing workstation to another, each workstation allowing implementation of at least one step according to the method of claim 9.
